(19) United States
(12) Patent Application Publication
(10) Pub. No.: US 2009/0001040 A1
(43) Pub. Date: Jan. 1, 2009

(54) HEAD BLOCK AND CONTAINER CRANE COMPRISING SUCH HEAD BLOCK

(75) Inventors: Rene Johannes Gerardus Kleiss, Schiedam (NL); Riemer De Jong, Delft (NL)

Correspondence Address: YOUNG & THOMPSON, 209 Madison Street, Suite 500, ALEXANDRIA, VA, 22314, US

(73) Assignee: KALMAR INDUSTRIES B.V., ROTTERDAM (NL)

(21) Appl. No.: 12/145,529

(22) Filed: Jun. 25, 2008

(30) Foreign Application Priority Data
Jun. 27, 2007 (EP) 07111162.9

(51) Int. Cl. B66C 1/00; B66C 13/06

(52) U.S. Cl. 212/242; 294/81.3; 212/270

(57) ABSTRACT

A hoisting frame or head block (1) for a container crane (17), comprises a frame structure (8) provided with two pairs of cable sheaves (5) which pairs are at a distance from each other in the longitudinal direction of the frame structure (8), connecting means (9) for connecting a secondary hoisting frame or spreader (2, 3) to the frame structure (8), a drive mechanism (12) for displacing the cable sheaves (5) of each pair with respect to each other in the transverse direction of the frame structure (8) between a small mutual rest position distance respectively a large mutual rest position distance, as well as rest position stabilisation means for stabilising the rest positions of the sheaves of each pair. The drive mechanism (12) is carried out for bringing the cable sheaves (5) of each pair at at least a minimal or at least a maximal mutual distance which is smaller respectively larger than the small respectively large mutual rest positions distances, and in that the rest position stabilisation means are activated upon displacing the cable sheaves (5) of each pair between said minimal respectively maximal mutual distances and said small respectively large mutual rest position distances.

The invention is related to a hoisting frame or head block for a container crane, comprising a frame structure provided with two pairs of cable sheaves which pairs are at a distance from each other in the longitudinal direction of the frame structure, connecting means for connecting a secondary hoisting frame or spreader to the frame structure, a drive mechanism for displacing the cable sheaves of each pair with respect to each other in the transverse direction of the frame structure between a small mutual rest position distance respectively a large mutual rest position distance, as well as rest position stabilisation means for immobilising the sheaves of each pair in said rest positions.

Such a prior art hoisting frame or head block is usually applied in those cases in which either a single container or a single row of containers is to be handled, or alternatively two containers positioned with the long sides next to each other or two rows of such containers next to each other. In the first case, that is the case for handling a single container, the head block is connected to a spreader, which has about the same width as the container. Consequently, the cable sheaves of the head block can be positioned relatively close to each other at a small mutual rest position distance, while still providing the required stability against lateral tilting. Moreover, the head block in this state has such limited lateral dimensions that it is possible to handle a container from within a field of containers which are closely positioned to each other, and in particular between two neighbouring rows of containers.

However, in the case of handling two containers next to each other, that is with the long sides thereof facing each other, care should be taken to ensure that the required stability is ascertained as well. The containers in question are each connected to a separate spreader, which two spreaders in turn are connected to the head block for instance via a sub frame. In order to achieve stability while handling containers next to each other, the sheaves of each pair are moved towards a position at a greater distance from each other, at a large mutual rest position distance. Thereby, any disequilibrium between the load exerted by two containers next to each other should be compensated.

According to a first prior art head block, the process of moving the cable sheaves of each pair is carried out manually. This entails a person climbing the head block, unlocking the cable sheaves in the first position, moving the cable sheaves to the second position, and subsequently locking the cable sheaves in said second position. Such process is however very disadvantageous for several reasons. First of all, the labour involved is heavy and dangerous as well. Moreover, changing the positions of the cable sheaves with respect to each other by hand is time-consuming and cumbersome, whereby the speedy process of loading or unloading containers is impaired.

According to a second prior art head block, the cable sheaves are supported by means of slide constructions. Said slide constructions can be driven to and fro by means of hydraulic piston/cylinder devices. The slide constructions are immobilised in the two end positions by means of manually or mechanically operated locking pins. Although the operation of such construction is improved by means of the piston/cylinder devices, the locking operation still requires considerable skill and separate handling as well as complicated locking means. This is caused by the fact that, first of all, the slide constructions should be brought in the proper position, and subsequently the locking pins will have to be introduced in the proper way.

The object of the invention is therefore to provide a head block as described before, which however can be handled in a more efficient, more safe and less cumbersome way. This object is achieved in that the drive mechanism is carried out for bringing the cable sheaves of each pair at at least a minimal or at least a maximal mutual distance which is smaller respectively larger than the small respectively large mutual rest positions distances, and in that the rest position stabilisation means are activated upon displacing the cable sheaves of each pair between said minimal respectively maximal mutual distances and said small respectively large mutual rest position distances.

As a result of such lay out, the advantage is obtained that the rest positions can be inherently stable. Once the cable sheaves have arrived in a rest position, they can be biased in said rest position under the influence of the cable forces. This means that the cable sheaves cannot inadvertently leave such rest positions, which means that the rest position stabilisation means are not very critical and can be carried out in a relatively simple way, for instance in the form of abutment surfaces. In that case, no actively operating locking devices are required, which simplifies the head block structure and which improves the reliability and safety thereof. Of course, additional locking devices could be added to the abutment type rest position stabilisation means, however these additional locking means do not provide the main stabilisation function but would instead be intended to function as a secondary safety means.

The rest position stabilisation means may either provide abutment forces in the small mutual rest position distance, or in the large mutual rest position distance, or in both the small and the large rest position distance of each pair of cable sheaves.

Further advantages are obtained by the circumstance that the cable sheaves can be displaced by means drive means. First of all, the displacement of the cable sheaves with respect to each other can now be remotely controlled, in particularly from the control cabin of the container crane. In addition, it is now no longer necessary for personal to climb the head block with the aim of changing the cable sheave positions with respect to each other. In general, the speedy process of loading and unloading containers, and changing between different spreaders for single or double container handling, is promoted.

The drive means for displacing the cable sheaves with respect to each other can be carried out in many different ways. According to a preferred embodiment, the drive means may comprise a rotatable element having an axis of rotation, as well as drive arms which each are connected to the rotatable element at a distance from the rotation axis thereof and which cooperate with a respective sheave, whereby a rotation of the rotatable element causes a movement of the sheaves towards or away from each other.

The rotating motion of the rotatable element can of course be obtained in several known ways, such as by means of an electric motor, hydraulic motor etcetera. Also, the orientation and rotational movement of the rotatable elements can be selected in different ways; however, preference is given to an embodiment wherein the axis of rotation of the rotatable element is directed according to the longitudinal direction of the frame structure.

A simultaneous movement of the cable sheaves of each pair can be obtained in an embodiment wherein at both ends of the rotatable element a pair of drive arms is provided, each pair of drive arms cooperating with the respective cable sheaves.

Each cable sheave can be rotatably connected to a support arm, said support arms each being pivotally connected to the frame structure. Said support arms carry the combined load of the head block, spreader and container(s) in question.

The pivot connection between the drive arm and a respective support arm is preferably positioned between the pivot connection of the support arm to the frame structure and the rotational connection of the cable sheave to the support arm. Furthermore, locking means are provided for locking the drive means in at least a state in which the sheaves are relatively close to each other, as well as in the state in which the sheaves are at a relatively large distance from each other.

The invention is furthermore related to a method of operating a hoisting frame or head block as described before, comprising the steps of:
activating the drive means so as to change the position of the cable sheaves of each pair with respect to each,
starting to displace the cable sheaves of each pair with respect to each other in a first direction towards a rest position wherein said sheaves have a mutual rest position distance,
continuing to displace said cable sheaves of each pair past said mutual rest position distance,
continuing to displace said cable sheaves of each pair to an extreme mutual distance,
displacing the cable sheaves of each pair from said extreme mutual distance in a second direction opposite to the first direction,
continuing to displace the cable sheaves of each pair in said second direction until said rest position with the mutual rest position distance is obtained,
stabilising the cable sheaves of each pair in said rest position by rest position stabilisation means which generate stabilisation forces while the cable sheaves of each pair attain the rest position,

In this method, the extreme position of the cable sheaves of each pair may be a minimal position or a maximal position, or both. In this connection, the method according to the invention may comprise the steps of:
starting to displace the cable sheaves of each pair towards a rest position in which said cable sheaves of each pair have a large mutual rest position distance,
continuing to displace said cable sheaves of each pair past said large mutual rest position distance,
continuing to displace said cable sheaves of each pair to a mutual distance which is maximal and larger than the large mutual rest position distance,
displacing the cable sheaves of each pair from said maximal mutual distance towards each other,
continuing to displace the cable sheaves of each pair towards each other until said rest position with the relatively large mutual rest position distance is obtained,
stabilising the cable sheaves of each pair in said rest position.

Alternatively or additionally, the method according to the invention may comprise the steps of:
starting to displace the cable sheaves of each pair towards a rest position in which said cable sheaves of each pair have a small mutual rest position distance,
continuing to displace said cable sheaves of each pair past said small mutual rest position distance,
continuing to displace said cable sheaves of each pair to a mutual distance which is minimal and smaller than the small mutual rest position distance,
displacing the cable sheaves of each pair from said minimal mutual distance away from each other,
continuing to displace the cable sheaves of each pair away from each other until said rest position with the small mutual rest position distance is obtained,
stabilising the cable sheaves of each pair in said rest position.

According to the invention, a stable and reliably immobilised position of the cable sheaves of each pair is achieved in all these embodiments by the steps of:
providing rest position stabilisation means which comprise opposite abutment surfaces,
making the abutment surfaces approach each other while moving the cable sheaves of each pair from the extreme mutual distance,
making the abutment surfaces abut onto each other while the cable sheaves of each pair attain the rest position.

As a result, an automatic stabilisation of the cable sheaves of each pair is obtained at the end of the displacement of said cable sheaves towards their rest positions.

The invention is furthermore related to a container crane, comprising a portal construction having a horizontal beam and carrying at least one carriage which is movable over said horizontal beam, said carriage being provided with hoisting cables, as well as a hoisting frame as described before, wherein said hoisting cables are guided around the sheaves of the hosting frame. Said container crane comprises a control cabin, wherein control means are provided comprising command means to be controlled within the control cabin, said command means being connected to the drive means for displacing the cable sheaves.

Thus, the container crane according to the invention with the head block as described before allows for the remote-controlled changing of spreaders from the control cabin thereof. As a result, it is no longer necessary to get additional personnel involved when changing crane service between handling of single containers or single rows of containers, and double containers or double rows of containers vice versa.

Moreover, the stability of the immobilised position of the sheaves is further enhanced by the way the cables extend between the head block and the carriage on the container crane boom. For instance, the pair of hoisting cables diverges upwardly from the cable sheaves which are in a rest position at a small mutual distance, and the carriage. Thereby, the cable abutment surfaces which define the small mutual rest position are firmly pressed onto each other. Alternatively or additionally, the pair of hoisting cables converges upwardly from the cable sheaves which are in a rest position at a large mutual distance, and the carriage. In this case, the abutment surfaces which define the large mutual rest position are firmly pressed onto each other. Thus, both in the small as well as in the large mutual rest position an inherently stable support of the cable sheaves is obtained.

The invention will now be described further with reference to an embodiment of the head block and the container crane.

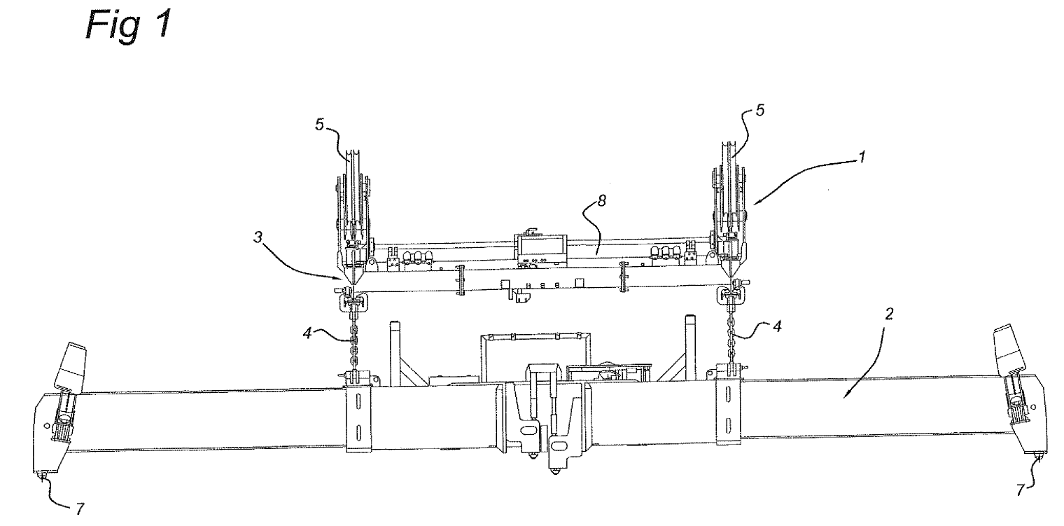

FIG. 1 shows a front view of a head block according to the invention.

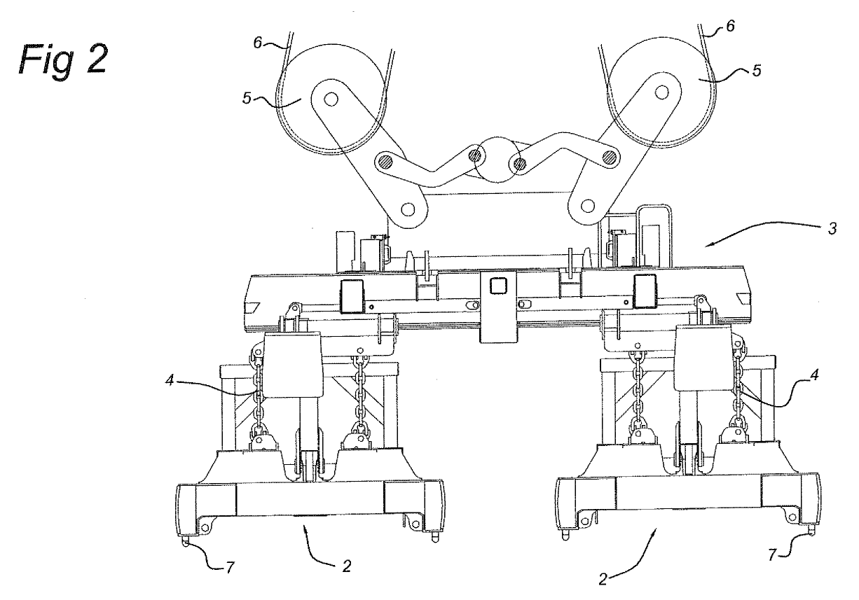

FIG. 2 shows a side view of the headblock carrying two spreaders and the cable sheaves at a large mutual rest position distance from each other.

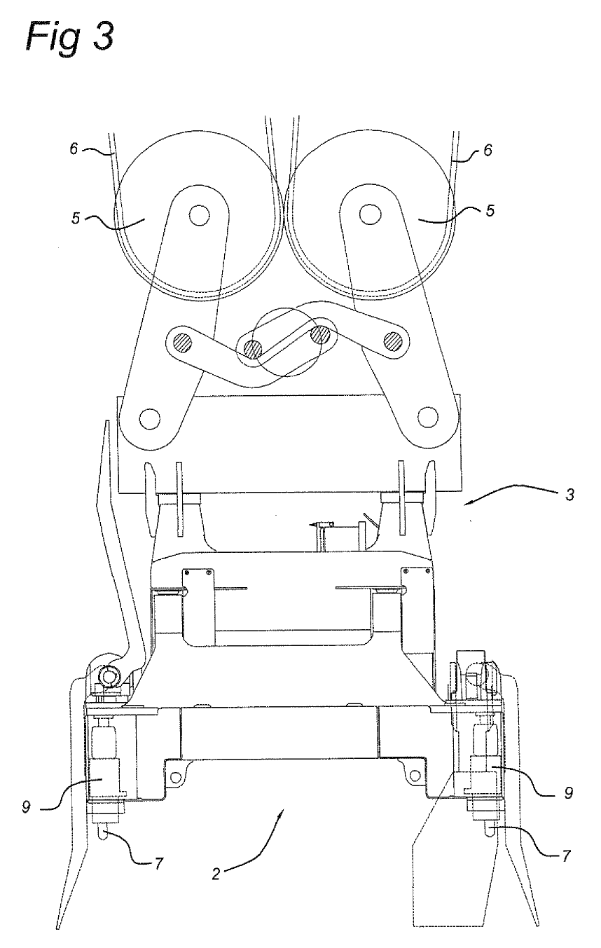

FIG. 3 shows the side view of the headblock carrying a single spreader and the cable sheaves at a small mutual rest position distance from each other.

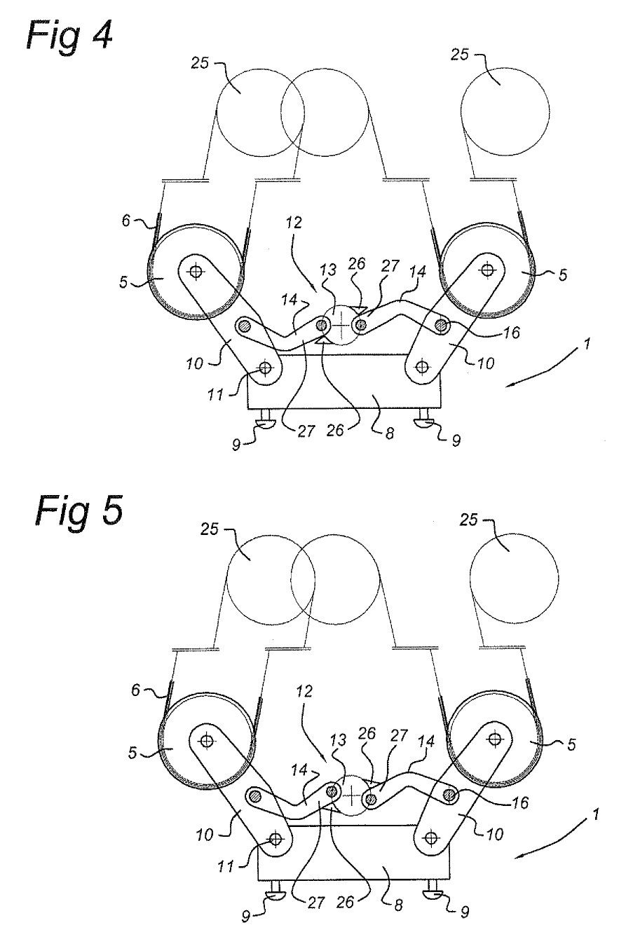

FIG. 4 shows the cable sheaves at the maximal mutual distance.

FIG. 5 shows the cable sheaves at the large mutual rest position distance.

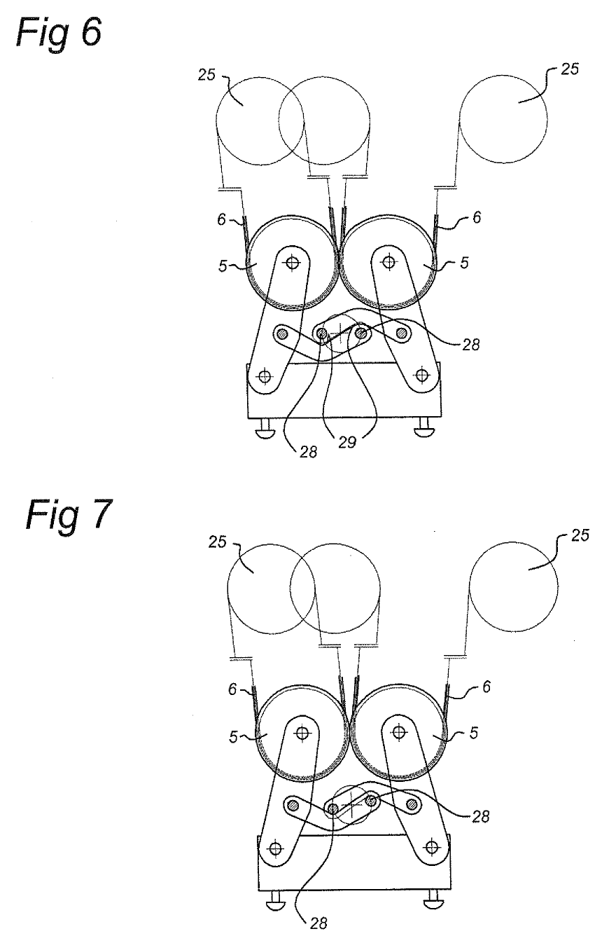

FIG. 6 shows the cable sheaves at the minimal mutual distance.

FIG. 7 shows the cable sheaves at the small mutual rest position distance.

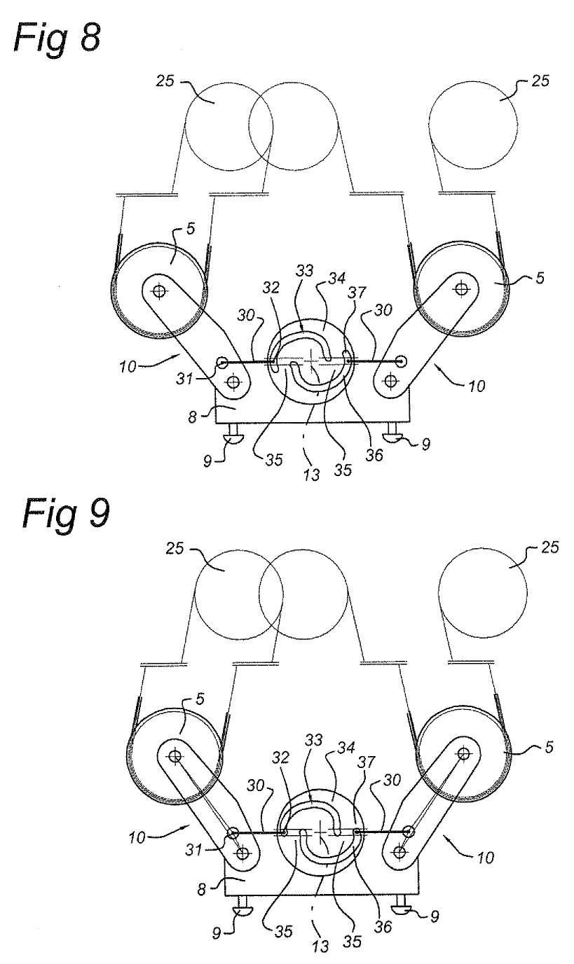

FIGS. 8-11 show positions corresponding to the positions of FIGS. 4-7 for an alternative embodiment.

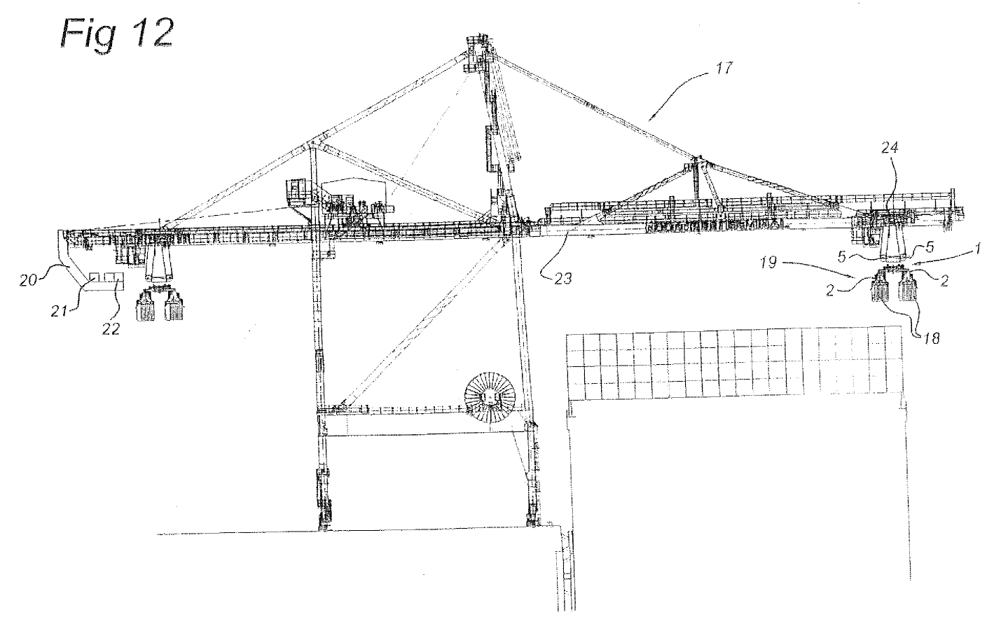

FIG. 12 shows a side view of a container crane.

In FIGS. 1 and 2, the head block 1 according to the invention is shown, which carries two spreaders 2 next to each other. Said spreaders 2 are suspended by means of chains 4 from a sub frame 3, which in turn is connected to the head block 1. The head block 1 carries two pairs of cable sheaves 5, around which the hoisting cables 6 are guided. In the state as shown in FIGS. 1 and 2, said cable sheaves 5 of each pair are at the relatively large distance from each other, or, in other words, at the large mutual rest position distance as will be explained further below. Such position of the cable sheaves 5 at a relatively large distance from each other provides the required stabilisation to the head block while handling two containers next to each other. As a result of this relatively large distance of the cable sheaves 5, the cables 6 run slantingly upwardly towards each other to the trolley sheaves (not shown in FIG. 2). In a known way, the spreaders 2 are provided with twist locks 7, for coupling a container thereto.

Thus, FIGS. 1 and 2 show the state in which the cable sheaves 5 are at a relatively large distance from each other. On a larger scale, this state is shown in FIG. 5 as well, FIG. 5 shows the head block 1, which comprises a rectangular frame structure 8. Said frame structure 8 carries at each corner twist locks 9 by means of which the subframe 3 as shown in FIG. 1 and 2 is coupled thereto. Furthermore, the frame structure 8 carries support arms 10 which are pivotally connected to said frame structure 8 through pivots 11, the axes of which are directed according to the longitudinal direction of the frame structure 8. At the free end of each support arm 10, a cable sheave 5 is rotatably connected. FIG. 2 shows a pair of cable sheaves 5 at one end of the head block 1, however a similar pair of cable sheaves 5 and support arms 10 is present at the other end of the head block 1 (see also FIG. 1).

For the purpose of rotating the support arms 10 between the positions shown in FIG. 5 and FIG. 4, drive means 12 are provided. Said drive means 12 comprise a drive shaft 13 as well as drive arms 14. Each drive arm 14 is connected to the drive shaft 13 by means of a pivot 15; at the other end, the drive arms 14 are connected to a corresponding support arm 10 by means of a pivot 16. By rotating the drive shaft 13 according to a counter-clockwise rotation, the support arms 10, and thus the corresponding cable sheaves 5, are moved from the relatively remote rest position (or large mutual rest position distance) as shown in FIG. 2 to the relatively close rest position 9 (or small mutual rest position distance) as shown in FIG. 3. Conversely, by rotating the drive shaft 13 according to a clockwise rotation, the cable sheaves 5 are moved from the close position as shown in FIG. 4 to the relatively remote rest position as shown in FIG. 2.

As already addressed before with reference to FIG. 2, the cables 6 run slantingly upwardly towards each other, to the trolley sheaves 25. Thus, said cables 6, which of course are under the tension, exert a force on the sheaves 5 which has a horizontal component trying to force said cable sheaves 5 towards each other. With the aim of making the position of the cable sheaves 5 as shown in FIG. 5 a stable one, the mutual distance of the cable sheaves 5 in said position is selected smaller than the maximal mutual distance of the cable sheaves 5 as shown in FIG. 4. This is also highlighted by the curved arrows shown in FIG. 4. The approximately 180° curved arrow 1. shows the rotation of the shaft 13 while rotating the support arms 10 and the associated cable sheaves 5 from the small mutual rest position as shown in FIG. 3, to the the maximum mutual distance as shown in FIG. 4. In this connection, it is important to note that the shaft 13 carries two radial shaft abutments 26, which are each opposite a respective drive arm 14, in particular the abutment surfaces 27 thereof. However, at said maximum mutual distance of the cable sheaves 5 as shown in FIG. 4, said radial shaft abutments 26 and the abutment surfaces 27 of the drive arms 14 have not come into contact with each other yet.

Consequently, the drive shaft 13 can be rotated somewhat further over the rotation distance indicated by arrow 2., after which the radial shaft abutments 26 come to lie against the opposite abutment surfaces 27 of the drive arms 14 as shown in FIG. 5. As the sheaves 5 had however already reached the maximum mutual distance after the rotation of the drive shaft 13 over the arrow 1., this further rotation of the drive shaft 13 over the arrow 2. makes the support arms 10 rotate toward each other. Consequently, the cable sheaves 5 move somewhat back towards each other, which means that their large mutual rest position distance as shown in FIG. 5 is somewhat smaller than their maximal mutual distance as shown in FIG. 4. Now turning to the fact that the cables 6 exert a force on the cable sheave 5 which tries to displace said cable sheaves 5 towards each other, which displacement is blocked by the coacting radial shaft abutments 26 and abutment surfaces 27 of the drive arms 14, the position shown in FIG. 5 is a stable one.

In the position shown in FIG. 3, the head block 1 is fit for connection to a single container, in which case the twist locks 9 can be directly applied to the corner castings of said container. In the first place, this relatively small mutual distance of the cable sheaves 5 provides sufficient stability for hoisting a single container. Furthermore, such small distance allows for the handling of containers between neighbouring rows of containers which are adjacent to each other, as is customary at container handling facilities. The latter position is shown in FIG. 7 as well, which shows that the cables now run slantingly abruptly out of each other towards the trolley sheaves 25. Consequently, as the cables 6 are under the tension, they exert a force on the cable sheaves 5 which has the component trying to move the cable sheaves 5 out of each other. With the aim of making the position of the cable sheaves 5 as shown in FIG. 7 a stable one, the mutual distance of the cable sheaves 5 in said position is larger than the minimal mutual distance of the cable sheaves 5 as shown in FIG. 6. This is also highlighted by the curved arrows shown in FIG. 6. The approximately 180° curved arrow 1. shows the rotation of the shaft 13 while rotating the support arms 10 and associated cable sheaves 5 from the large mutual rest position as shown in FIG. 2, to the the minimum mutual distance as shown in FIG. 6. In this connection, it is important to note that the shaft 13 carries two axial shaft abutments 28, which are each opposite a respective drive arm 14, in particular the abutment surfaces 29 thereof However, in the minimum mutual distance of the sheaves 5 as shown in FIG. 6, said radial shaft abutments 28 and the abutment surfaces 29 of the drive arms 14 have not come into contact with each other yet.

Consequently, the drive shaft 13 can be rotated somewhat further over the rotation distance indicated by arrow 2., after which the radial shaft abutments 28 come to lie against the opposite abutment surfaces 29 of the drive arms 14 as shown in FIG. 7. As the sheaves 5 had however already reached the minimum mutual distance after the rotation of the drive shaft 13 over the arrow 1., this further rotation of the drive shaft 13 makes the support arms 10 rotate out of each other. Consequently, the cable sheaves 5 move somewhat back out of each other, which means that their small mutual rest position distance as shown in FIG. 7 is somewhat larger than their minimal mutual distance as shown in FIG. 6. Now turning to the fact that the cables 6 exert a force on the cable sheave 5 which tries to displace said cable sheaves 5 out of each other, which displacement is blocked by the coacting axial shaft abutments 28 and abutment surfaces 29 of the drive arms 14, the position shown in FIG. 7 is a stable one.

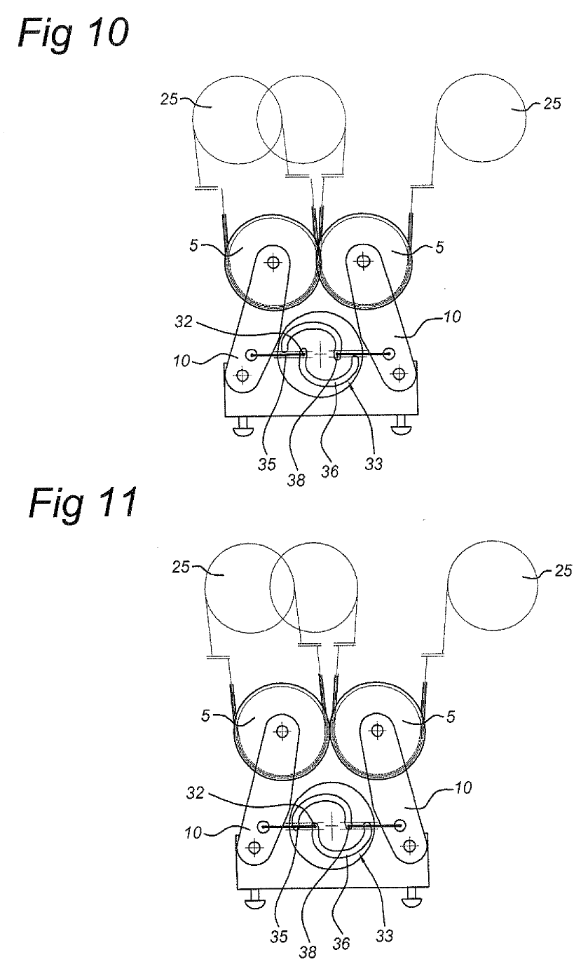

An alternative embodiment of the headblock according to the invention is shown in the FIGS. 8-11. said alternative the headblock is to a large extent similar to the headblock described before, however the maximum mutual distance as shown in FIG. 8, the large mutual rest position as shown in FIG. 9, the minimum mutual distance as shown in FIG. 10 and the small mutual rest position distance as shown in FIG. 11 are obtained in a different way. In this connection, the drive arms 10 are each through a pivot 31 connected to a respective control rod 30. The end of the control rod 30 opposite the pivot 31 comprises a slide block 32. The drive shaft 13 carries a control disk 34, which control disk 34 is provided with two similar control grooves 33. The slide block 32 of each control rod 30 is accommodated in a respective groove 33, in such a way that the control groove 33 moves past the slide block 32in case the control disc 34 is rotated. Furthermore, the slide block 32 is slidably accommodated in a radially extending guide which is fixed to the frame 8.

The shape of the control groove 33 is carried out in such a way that upon rotating the drive shaft 13, and thus the control disk 34 over the arrow 1., the maximum mutual distance of the cable sheaves 5 as shown in FIG. 8 is obtained. This is achieved by the somewhat spiral shape of the middle part 36 of the control groove 33. Further rotation of the drive shaft 13 and the control disk 34 over the arrow 2. makes the support arms 10 and the cable sheaves 5 move somewhat towards each other to the large mutual rest position distance as shown in FIG. 9. This is caused by the fact that the outer end part 37 of the control groove 33 has a slightly inwardly bent configuration, that is to say to that said outer end part 37 is bent towards a smaller diameter. After the slide block 32 has arrived in this end part 37 of the control groove 33, a stable position is obtained as shown in FIG. 9 for the same reasons as explained before with respect to the embodiment shown in the FIGS. 4-7.

Similarly, than rotating the control autumn 13 and the control disk 34 over the arrow 1. as shown in FIG. 10, the minimum mutual distance of the cable sheaves 5 is obtained. The inner end part 38 of the control groove 33 has a slightly outwardly bent configuration, that is to say that said inner and part 38 is bent towards a larger diameter. Thus, while rotating the control disc 34 further over the arrow 2., the cable sheaves 5 have moved somewhat out of each other to the small mutual rest position distance as shown in FIG. 11. In their position, stability is obtained has explained before.

The head block 1 according to the invention is used in the container crane 17 as shown in FIG. 12, said head block 1 being shown in the position with the cable sheaves 5 at a relatively remote distance for handling two spreaders 2 next to each other, each with a container 18 connected thereto. Said container crane 17 comprises a horizontal beam 23, along which the carriage 24 is displaceable from the ship side on the right end of the crane, to the shore side on the left end of the crane 17. Furthermore, the horizontal beam 23 carries a control cabin 19, equipped with command means for operating the head block 1. Said container crane 17 is furthermore equipped, at the shore side, with a platform 20 accommodating different types of spreaders, which can be picked up or off loaded by means of the head block 1. Thus, said platform 20 has a position 21 for holding a single spreader, as well as a position for holding a double spreader combination as shown in FIGS. 1 and 2. In the embodiment shown, the double spreader combination is connected to the head block 1, whereas the single spreader is positioned on the platform 20. In case it becomes necessary to handle single containers 18 or a single row of such containers, the head block with double spreader combination is moved towards the platform 20. Subsequently, under remote control said double spreader combination is positioned on the platform 20 and is detached from the head block 1 under remote control as well by manipulating the twist locks 9 thereof. Then, the head block 1 is moved above the single spreader positioned on the platform 20 as well, and under remote control the head block 1 is connected to said single spreader by manipulating the twist locks 9 again. Finally, the head block 1 equipped with a single spreader is moved towards the location for handling single containers or a single row of containers.

It will be clear that the process of changing spreaders by means of the head block 1 according to the invention is completely carried out under remote control from the control cabin 19, which has the great advantage that no personal is necessary for mounting or dismounting spreaders manually.

1. Hoisting frame or head block (1) for a container crane (17), comprising a frame structure (8) provided with two pairs of cable sheaves (5) which pairs are at a distance from each other in the longitudinal direction of the frame structure (8), connecting means (9) for connecting a secondary hoisting frame or spreader (2, 3) to the frame structure (8), a drive mechanism (12) for displacing the cable sheaves (5) of each pair with respect to each other in the transverse direction of the frame structure (8) between a small mutual rest position distance respectively a large mutual rest position distance, as well as rest position stabilisation means for stabilising the rest positions of the sheaves of each pair, characterised in that the drive mechanism (12) is carried out for bringing the cable sheaves (5) of each pair at at least a minimal or at least a maximal mutual distance which is smaller respectively larger than the small respectively large mutual rest positions distances, and in that the rest position stabilisation means are activated upon displacing the cable sheaves (5) of each pair between said minimal respectively maximal mutual distances and said small respectively large mutual rest position distances.

2. Hoisting frame according to claim 1, wherein the drive mechanism (12) is carried out for bringing the cable sheaves (5) of each pair at a minimal and a maximal mutual distance which are smaller respectively larger than the small respectively large mutual rest positions distances, and in that the rest position stabilisation means comprise abutment surfaces (26-29) which abut onto each other while displacing the cable sheaves (5) of each pair from said minimal respectively maximal mutual distances to said small respectively large mutual rest position distances.

3. Hoisting frame according to claim 1, wherein the rest position stabilisation means stabilise or immobilise the cable sheaves (5) against transverse displacement forces exerted on the sheaves by respective hoisting cables, and abutment forces being generated under the influence of said transverse displacement forces.

4. Hoisting frame (1) according to claim 1, wherein the drive means (12) comprise a rotatable element (13) having an axis of rotation, as well as drive arms (14) which each are connected to the rotatable element (13) at a distance from the rotation axis thereof and which cooperate with a respective cable sheave (5), whereby a rotation of the rotatable element (13) causes a movement of the cable sheaves (5) towards or away from each other.

5. Hoisting frame (1) according to claim 4, wherein the axis of rotation of the rotatable element (13) is directed according to the longitudinal direction of the frame structure (8).

6. Hosting frame (1) according to claim 4, wherein a pair of drive arms (14) is provided at both ends of the rotatable element (13), each pair of drive arms (14) cooperating with respective cable sheaves (5).

7. Hosting frame (1) according to claim 1, wherein each cable sheave (5) is rotatably connected to a support arm (10), said support arms (10) each being pivotally connected to the frame structure (8).

8. Hoisting frame (1) according to claim 7, wherein each drive arm (14) is pivotally connected to a respective support arm (10).

9. Hosting frame (1) according to claim 8, wherein the pivot axes of the pivot connections (11) between each support arm (10) and the frame structure (8) are oriented according to the longitudinal direction of said frame structure (8).

10. Hoisting frame according to claim 8, wherein the pivot connection (16) between the drive arm (14) and a respective support arm (10) is positioned between the pivot connection (11) of the support arm (10) to the frame structure (8) and the rotational connection of the cable sheave (5) to the support arm (10).

11. Hoisting frame (1) according to claim 1, wherein the rotation axes of the cable sheaves (5) are oriented according to the longitudinal direction of the frame structure (8).

12. Hoisting frame (1) according to claim 1, wherein the drive means (12) comprise a rotatable element (34) having an axis of rotation, as well as drive arms (30) which are slidable in radial direction with respect to the roatable element (34) and which each cooperate with the rotatable element (13) at a distance from the rotation axis thereof and which cooperate with a respective cable sheave (5) through curved trajectories (33) which are noncircular, whereby a rotation of the rotatable element (34) causes a movement of the cable sheaves (5) towards or away from each other.

13. Method of operating a hoisting frame or head block according to any of the preceding claims, comprising the steps of:
activating the drive means so as to change the position of the cable sheaves of each pair with respect to each,
starting to displace the cable sheaves of each pair with respect to each other in a first direction towards a rest position wherein said sheaves have a mutual rest position distance,
continuing to displace said cable sheaves of each pair past said mutual rest position distance,
continuing to displace said cable sheaves of each pair to an extreme mutual distance,
displacing the cable sheaves of each pair from said extreme mutual distance in a second direction opposite to the first direction,
continuing to displace the cable sheaves of each pair in said second direction until said rest position with the mutual rest position distance is obtained,
stabilising the cable sheaves of each pair in said rest position by rest position stabilisation means which generate stabilisation forces while the cable sheaves of each pair attain the rest position.

14. Method according to claim 13, comprising the steps of:
starting to displace the cable sheaves of each pair towards a rest position in which said cable sheaves of each pair have a large mutual rest position distance,
continuing to displace said cable sheaves of each pair past said large mutual rest position distance,
continuing to displace said cable sheaves of each pair to a mutual distance which is maximal and larger than the large mutual rest position distance,
displacing the cable sheaves of each pair from said maximal mutual distance towards each other,
continuing to displace the cable sheaves of each pair towards each other until said rest position with the relatively large mutual rest position distance is obtained,
stabilising the cable sheaves of each pair in said rest position.

15. Method according to claim 13, comprising the steps of:
starting to displace the cable sheaves of each pair towards a rest position in which said cable sheaves of each pair have a small mutual rest position distance,
continuing to displace said cable sheaves of each pair past said small mutual rest position distance,
continuing to displace said cable sheaves of each pair to a mutual distance which is minimal and smaller than the small mutual rest position distance,
displacing the cable sheaves of each pair from said minimal mutual distance away from each other,
continuing to displace the cable sheaves of each pair away from each other until said rest position with the small mutual rest position distance is obtained,
stabilising the cable sheaves of each pair in said rest position.

16. Method according to any of claim 13, comprising the steps of:
providing rest position stabilisation means which comprise opposite abutment surfaces,
making the abutment surfaces approach each other while moving the cable sheaves of each pair from the extreme mutual distance,
making the abutment surfaces abut onto each other while the cable sheaves of each pair attain the rest position.

17. Container crane (17), comprising a portal construction having a horizontal beam (23) and carrying at least one carriage (24 which is movable over said horizontal beam (23), said carriage (24) being provided with hoisting cables (6), as well as a hoisting frame (1) according to claim 1, wherein said hoisting cables (6) are guided around the cable sheaves (5) of the hosting frame (8).

18. Container crane (17) according to claim 17, wherein a pair of hoisting cables (6) corresponds to a pair of cable sheaves (5), said pair of hoisting cables (6) diverging upwardly from the cable sheaves (5) which are in a rest position at a small mutual distance, and the carriage (24).

19. Container crane (17) according to claim 17, wherein a pair of hoisting cables (6) corresponds to a pair of cable sheaves (5), said pair of hoisting cables (6) converging upwardly from the cable sheaves (5) which are in a rest position at a large mutual distance, and the carriage (24).

20. Container crane (17) according to claim 17, comprising a control cabin (19), wherein control means are provided comprising command means to be controlled within the control cabin, said command means being connected to the drive means (12) for displacing the cable sheaves (5).
